(19) United States
(12) Patent Application Publication
(10) Pub. No.: US 2021/0049677 A1
(43) Pub. Date: Feb. 18, 2021

(54) SYSTEM AND METHOD FOR ELECTRONIC RENTAL PLATFORM

(71) Applicant: ROYAL BANK OF CANADA, Toronto (CA)

(72) Inventors: Jenny GUAN, Toronto (CA); Benjamin LABRECQUE, Toronto (CA); MD Mohaimen Hassan KHAN, Toronto (CA); Mandy Man-Yang CHEUNG, Toronto (CA); Ryan HURON, Toronto (CA)

(21) Appl. No.: 16/994,138

(22) Filed: Aug. 14, 2020

Related U.S. Application Data
(60) Provisional application No. 62/886,607, filed on Aug. 14, 2019.

(51) Int. Cl. G06Q 30/06; G06Q 30/08; G06Q 30/02; G06Q 40/02; G06Q 50/16; G06F 16/2455

(52) U.S. Cl. CPC G06Q 30/0645; G06Q 30/08; G06Q 30/0201; G06Q 40/02; G06F 3/0482; G06Q 50/16; G06Q 30/0205; G06F 16/24568; G06F 16/24556; G06Q 30/0206

(57) ABSTRACT

A system, non-transitory computer-readable medium, and method are provided. The system comprises at least one processor and memory storing instructions which when executed by the at least one processor configure the at least one processor to perform the method. The non-transitory computer-readable medium has instructions thereon, which when executed by a processor, perform the method. The method comprises providing a demand-side user interface offering at least one rental property, determining a bid price for user to offer for the at least one rental property, and matching the user with the rental property.

### FIELD

The present disclosure generally relates to a system and method for electronic rental platform.

### INTRODUCTION

There exists software to assist people to find rental properties. However, there is no platform currently that allows renters to match with listings before they are on the market to the general public.

### SUMMARY

In accordance with an embodiment, there is provided a system comprising at least one processor and memory storing instructions which when executed by the at least one processor configure the at least one processor to provide a demand-side user interface offering at least one limited-supply product or service, determine a bid price for a user to offer for the at least one limited-supply product or service, and match the user with the at least one limited-supply product or service.

In accordance with another embodiment, there is provided a method comprising providing a demand-side user interface offering at least one limited-supply product or service, determining a bid price for a user to offer for the at least one limited-supply product or service, and matching the user with the at least one limited-supply product or service.

In accordance with another embodiment, there is provided a non-transitory computer-readable medium having instructions thereon which, when executed by a processor, perform a method comprising providing a demand-side user interface offering at least one limited-supply product or service, determining a bid price for a user to offer for the at least one limited-supply product or service, and matching the user with the at least one limited-supply product or service.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates, in a component diagram, an example of an architecture for an electronic rental system, in accordance with some embodiments;

FIG. 2 illustrates, in a flowchart, an example of a method of pre-processing financial data to extract relevant limited-supply product or services transactions, in accordance with some embodiments.

FIG. 3 illustrates, in a graph, an example of a data structure, in accordance with some embodiments;

FIG. 4 illustrates, in a flowchart, an example of a process flow, in accordance with some embodiments;

FIG. 5 illustrates, in a flowchart, an example of a process flow, in accordance with some embodiments;

FIG. 6 illustrates, in a screenshot, an example of a login screen for the electronic rental system, in accordance with some embodiments;

FIGS. 7 to 13 illustrate, in screenshots, an example of supply side user interface pages after login for the electronic rental system, in accordance with some embodiments;

FIGS. 14 to 15 illustrate, in screenshots, an example of supply-side dashboards for the electronic rental system, in accordance with some embodiments;

FIG. 16 illustrates, in a screenshot, an example of a demand-side dashboard for the electronic rental system, in accordance with some embodiments;

FIGS. 17 to 23 illustrate, in screenshots, an example of demand-side user interface pages after login for the electronic rental system, in accordance with some embodiments;

FIG. 24 illustrates, in a screenshot, another example of a demand-side dashboard for the electronic rental system, in accordance with some embodiments; and

FIG. 25 is a schematic diagram of a computing device such as a server.

It is understood that throughout the description and figures, like features are identified by like reference numerals.

### DETAILED DESCRIPTION

Embodiments of methods, systems, and apparatus are described through reference to the drawings.

In some embodiments, an application may be built to create a rental community for insider information and exclusive listings. Renters who are moving out (e.g., in 3 months) may be matched with other renters who are looking for a rental unit that meets their desired criteria before the unit goes to market. Thus, a competitive advantage is offered to users of the application.

In some embodiments, a matching feature equips users with valuable insights about listings that were specifically designed to make the users more competitive with respect to time saved in rental searches and/or information available that the users may use to leverage their application among others. In some embodiments, a suggested offer price is provided which users may use as a benchmark when making a rental offer.

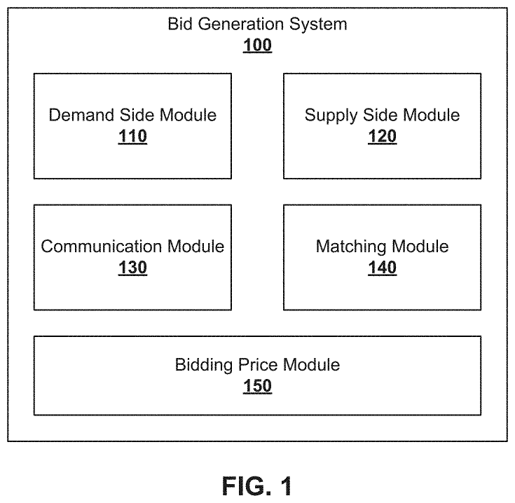

FIG. 1 illustrates, in a component diagram, an example of a bid generation system 100, in accordance with some embodiments. The system 100 comprises a demand side module 110, a supply side module 120, a communications module 130, a matching module 140, and a bidding price module 150. Other components may be added to the system 100. The bid generation system 100 may be used to electronically generate bids for limited-supply products or services. In some embodiments, a notification may be sent to a user providing notification of the availability of the limited-supply product or service and the generated bid price.

In some embodiments, the system 100 is targeted to the rental market. In some embodiments, the system 100 provides a competitive edge for rental property seekers. The matching module 140 may match a potential renter with a property that is about to be listed. A matching algorithm may be used that factors a price range, location, amenities, number of beds and baths, desired move-in date, etc. The bidding price module 150 may obtain historical rental data (including price) and apply a linear regression to estimate a price. Other data may be used such as data received from renter surveys (e.g., bid price for current rental property, actual rent). Some surveys have shown that users that placed a bid for a rental property have typically secured the property 80% of the time. As such, in some embodiments, a confidence rate of 80% may be applied to a suggested bid price.

In some embodiments, data used to estimate a bid price may be pre-processed from financial data. Data pre-processing includes analyzing and extracting proprietary financial data related to the limited-supply product or service (e.g., rental transactions) and aggregating this information in an anonymized fashion. Using industry standard transaction codes, as well as methodologies developed to identify limited-supply product or service transactions (e.g., rental transactions) via proxies, financial institutions may to collect data of its clients as it relates to their rental transactions. This proxy methodology includes looking at recurring transactions from pre-authorized payments, e-transfer, cheques or other mechanisms to pay for the limited-supply product or service (e.g., pay rent). In some embodiments, a minimum number of months that this transaction has recurred, and a consistent dollar amount for the transaction, may be used to classify the transaction as a recurring rental transaction. This data is collected historically and at present to be able to monitor changes and trends over time. The data may be aggregated to specific geographic areas such as dissemination area to help anonymize the information and to calculate yearly change in rental price in each dissemination area.

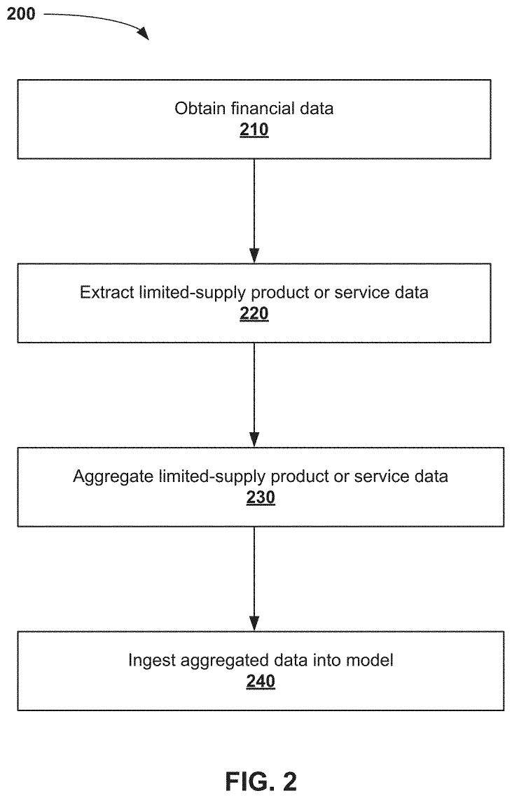

FIG. 2 illustrates, in a flowchart, an example of a method 200 of pre-processing financial data to extract relevant limited-supply product or services transactions, in accordance with some embodiments. The method 200 involves obtaining raw financial transaction data 210. Such raw financial transaction data may be stored and retrieved from data stores comprising normal banking operations. This can include debit transactions, pre-authorized payments, e-transfers and other types of transactions.

Next, transaction pertaining to limited-supply products or services (e.g., rental data) may be extracted 220 from the raw data. In some embodiments, transform scripts may be used to extract and transform raw financial institution data into usable limited-supply product or service data (e.g., rental data). These scripts may rely on using financial industry transaction codes and a proxy methodology to identify limited-supply product or service transactions (e.g., rental transactions). For example, a proxy methodology may identify recurring rental transactions from financial institution clients with transaction codes related to pre-authorized payments, e-transfer and other types of rental transactions. As noted above, the proxy methodology may count the distinct months that an individual client has transacted with approximately the same amount of dollars with the associated transaction code. In some embodiments, a minimum of months (e.g., 4 distinct months) of consecutive transactions, and the transaction amounts to be between a set range (e.g., $500 and $10,000) allows for the transaction to be classified as a limited-supply product or service transaction (e.g., rental transaction). In some embodiments, this is done on a client level to obtain a monthly rental price and data is then aggregated to anonymize the findings at a geographic level such as forward sortation area or dissemination area.

Next, data may be aggregated 230. In some embodiments, using the transformed data obtained from the previous step 220, historical and current information may be aggregated 230 to specific geographic areas such as forward sortation areas or dissemination areas in order to help anonymize the information and calculate yearly change in rental price. Once the data has been aggregated 230, the data may be ingested (or input) 240 into a bid determination model for further feature engineering and modelling. This ingestion 240 may occur on an ongoing basis or be on a more infrequent basis, as deemed necessary. For example, for some limited-supply products or services, a quarterly or yearly update may be sufficient for pricing needs. For other limited-supply products or services, a monthly, weekly or even more frequent (including near-real-time) update may be performed so that a bid pricing model may use the most updated information.

In some embodiments, the model and process flow uses multiple data feeds including financial institution data, limited-supply product or service application data (e.g., rental applications data) and third party data. The role of financial institution data is primarily to provide an ongoing feed of anonymized confirmed and proxy rental transactions, which forms the basis of the model. Rental applications (e.g., Get Digs) data provides an opportunity to identify vacant or soon to be vacant rental properties prior to actually going on the market. For example, this differentiating feature allows the system 100 to pro-actively connect prospective renters with properties before reaching the open market and allow them to offer a competitive rental bid using our bidding price model. Third party data may also be used to improve the model accuracy and usability and could include both acquired and open data sources.

Feature engineering allows the system 100 to extract the features from raw data, including financial institution sources, rental application (e.g., Get Digs) sources and third party sources, to improve the performance of the modelling. In some embodiments, a primary feature that may be used in the model is historical rental prices. However, other features may be used in the modelling which may include: square footage of home, number of bedrooms, number of bathrooms, neighborhood criteria (e.g., proximity to grocery, transit) and others.

In some embodiments, the model focuses on using historical rental data and linear regression to calculate yearly change in limited-supply product or service price (e.g., rental price) and predict future price. Other model considerations could include using more advanced machine learning techniques in order to improve accuracy of the bidding price and improve user experience. For example, Lasso, ElasticNet, Ridge Regression or even neural network regression techniques may be used.

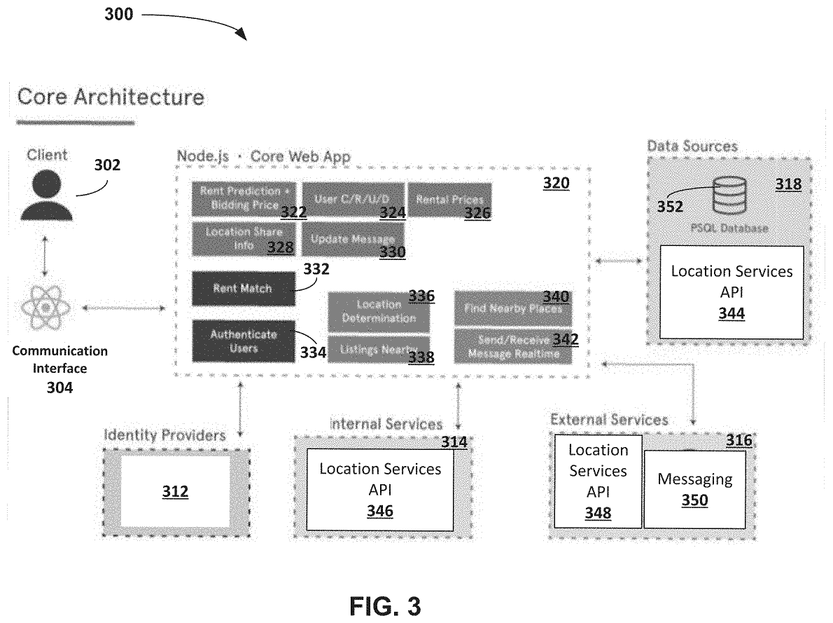

FIG. 3 illustrates, in a component diagram, an example of an architecture 300 for an electronic rental system, in accordance with some embodiments. A client 302 may interact with the electronic rental bid generation system 300 via an interface 304. The system 300 also interacts with one or more identity providers 312, internal services 314 (e.g., location services application programing interface (API) 346), external services 316 (e.g., location services API 348, messaging services 350), and data sources 318 (e.g., database 352, location services API 344, etc.). Other components may be added to the architecture 300. The system 300 may comprise a rent prediction and bidding price unit 322 for generating a bid price, a user create/read/update/delete (C/R/U/D) unit 324 for modification of user data, a rental prices unit 326, a location share info unit 328, an update message unit 330, a rent match unit 332, an authentication unit 334, a location determination unit 336, a listing nearby unit 338, a find nearby places unit 340 and a send/receive message realtime unit 342.

Bidding price is an item that renters may hire real estate agents to provide. However, the system 100, 300 will be able to display an average rental bidding price, allowing users to move forward with a competitive offer, while they secure a rental. In some embodiments, the bidding price may be calculated as follows:

(current price+increase trend)+/−confidence interval

The current price may comprise the current average rental data found from the location. The increase trend may be obtained by analysing historical prices. The historical prices may be aggregated based on location into dissemination areas to calculate the average rent price per dissemination area for each year. A linear regression may then be applied to calculate yearly change in rental price in each dissemination area. From the linear regression, a standard deviation may be obtained and the confidence interval may be calculated as:

Z-value * standard deviation

In some examples, a normal distribution of the data may be assumed. In some embodiments an 80% confidence interval was used, meaning that the price that will be agreed upon when signing the lease will likely fall within the suggested interval with a probability of 0.8, the corresponding Z-value is 1.28, which can be looked up in a table.

An average rental price within a dissemination area may be pulled from aggregated data. Thus, the bidding interval may be:

$$\overline{x} \pm z \frac{s}{\sqrt{n}}$$

for each dissemination area. It is understood that as user base increases thereby providing a richer set of data, a more complex online-learning method may be applied to predict rental prices more accurately.

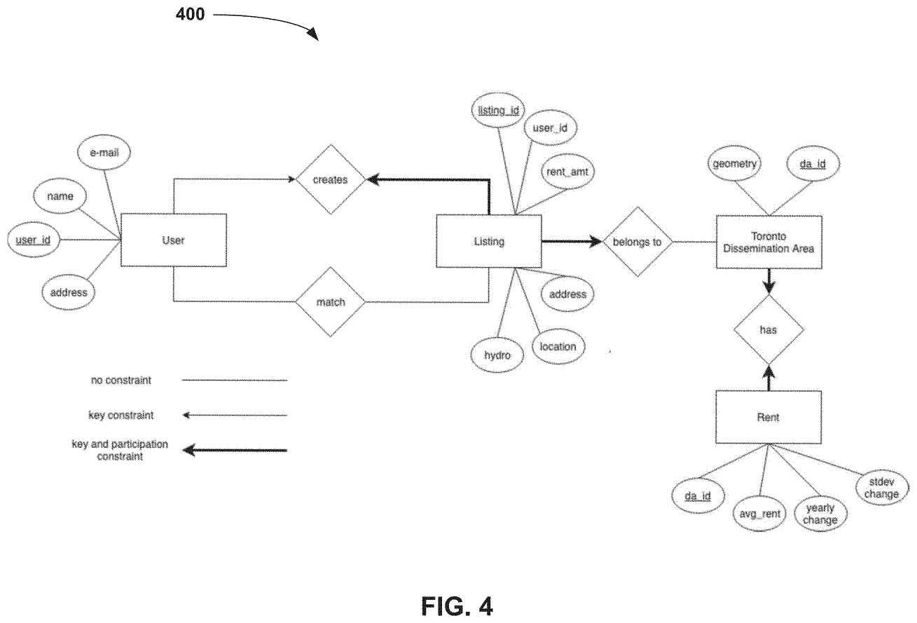

FIG. 4 illustrates, in a graph, an example of a data structure 400, in accordance with some embodiments. The data structure 400 may be used in a rental system 300 scenario, but may be modified for any limited-supply product or service bid generation system 100.

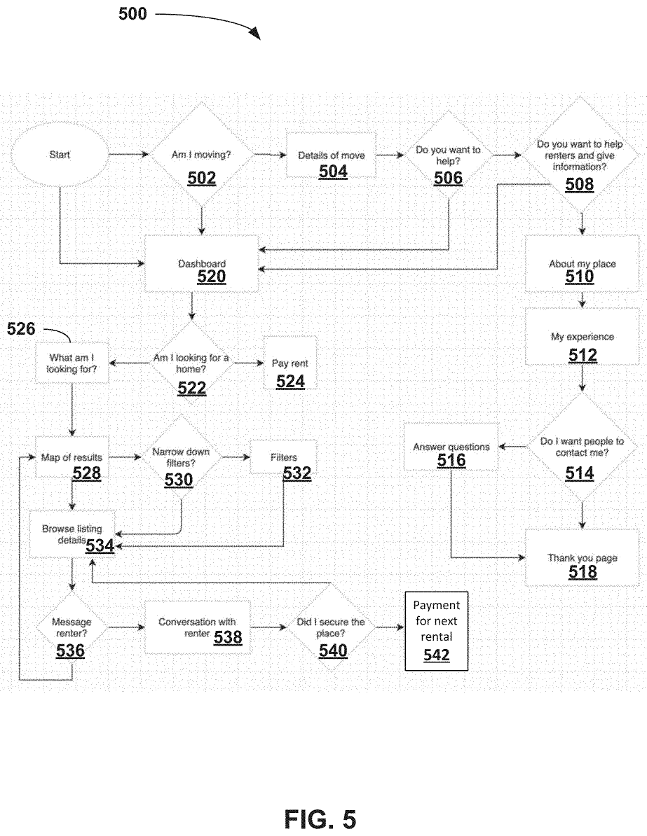

FIG. 5 illustrates, in a flowchart, an example of a process flow 500, in accordance with some embodiments. The process flow 500 may be used in a rental system 300 scenario, but may be modified for any limited-supply product or service bid generation system 100. The process 500 begins with a user noting if they are moving 502. Details of the move are collected 504. If the user agrees to provide information/feedback regarding their current rental unit 506, 508, then information regarding the user's rental unit 510 and their experience 512 is collected. If the user agrees to allow others to contact them 514, then questions provided by other users are answered 516 and the user may then receive an appreciation notification 518.

If the user did not agree to provide information/feedback regarding their current rental unit 506, 508, then a system dashboard 520 is provided to assist the user locate another property. If the user is not searching for a home 522, then the user could pay rent 524 after securing a rental property. If the user is searching for another home 522, then information regarding what the user is looking for 526, search results 528 are displayed. The results may be narrowed using filters 530, 532 and the details of the results may be browsed 534. The user may attempt to message 526 and converse 528 with the current renter for one of the search results. If a place was secured 540, then the payment for the next rental is determined 542.

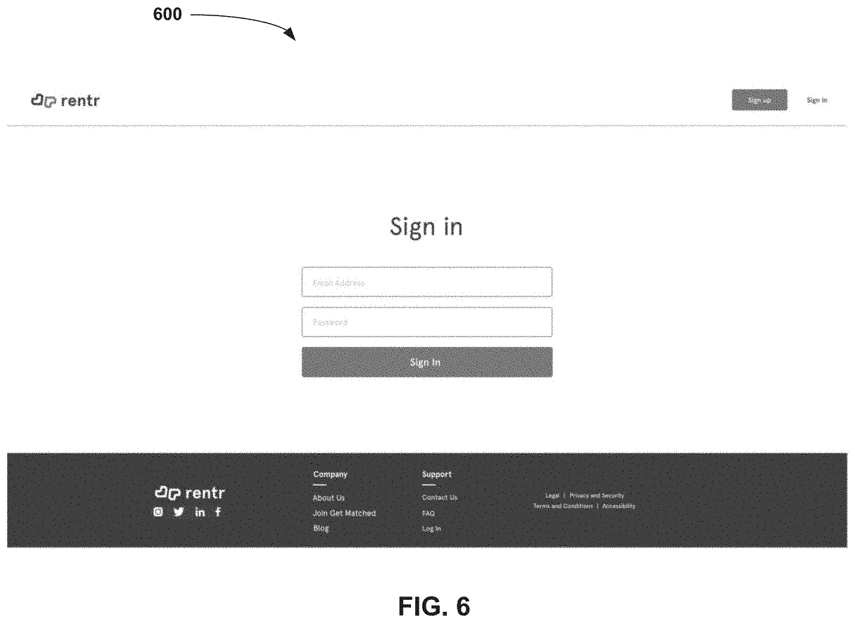

FIG. 6 illustrates, in a screenshot, an example of a login screen 600 for the electronic rental system 300, in accordance with some embodiments.

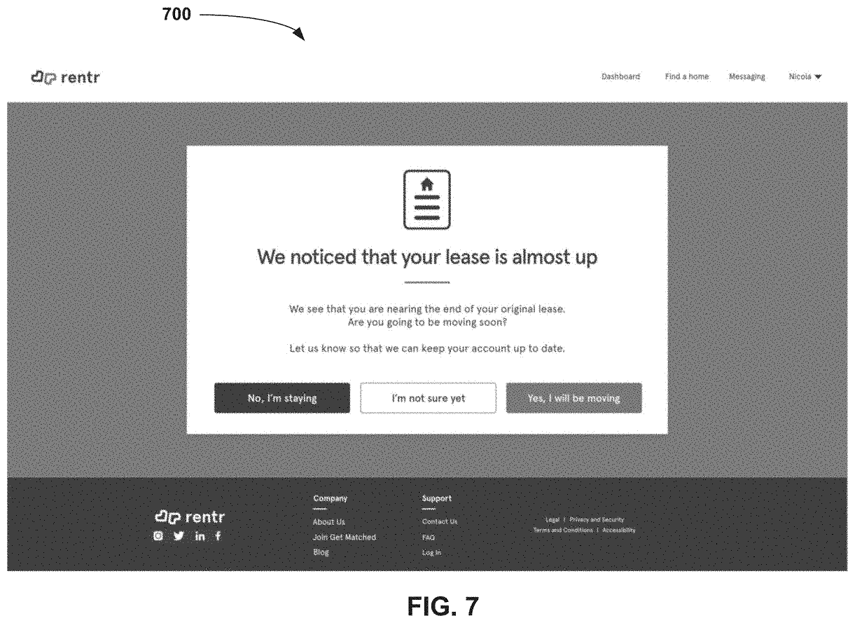

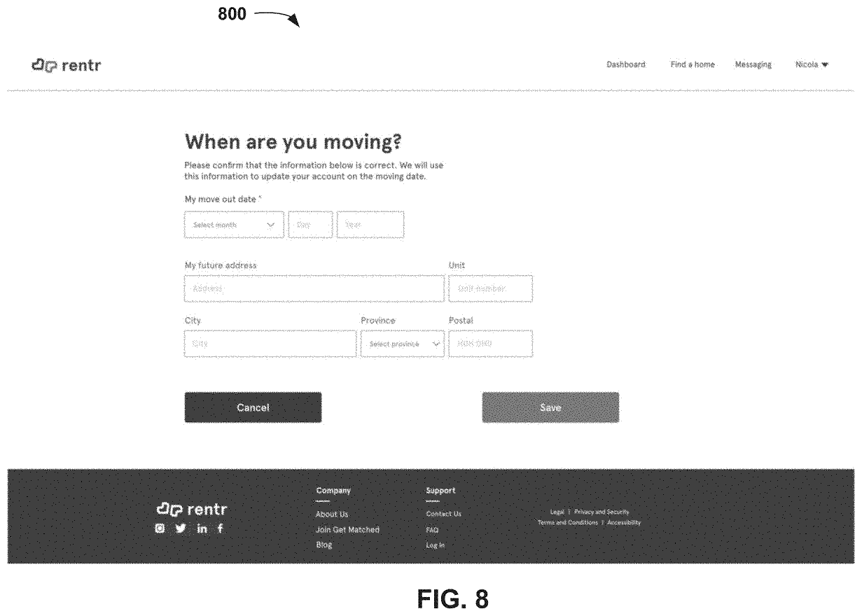

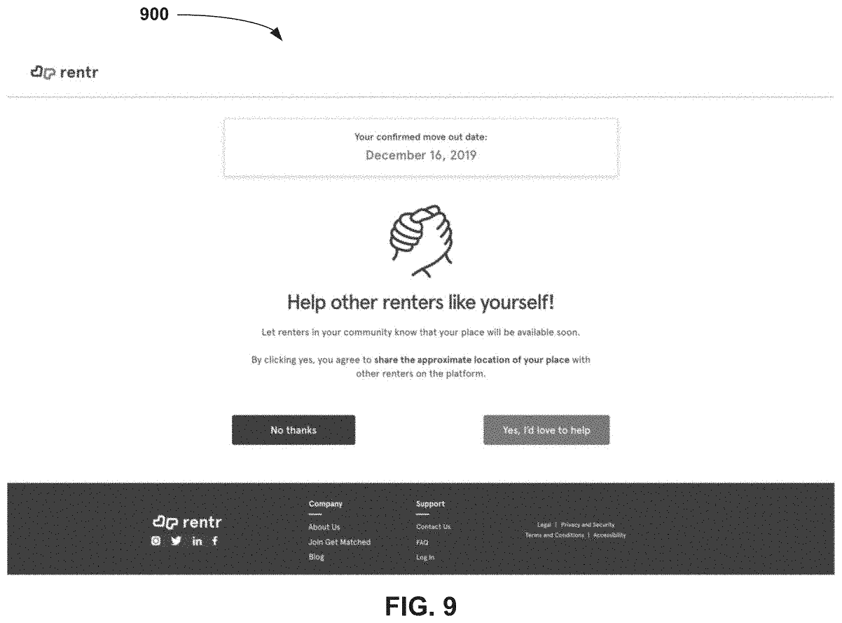

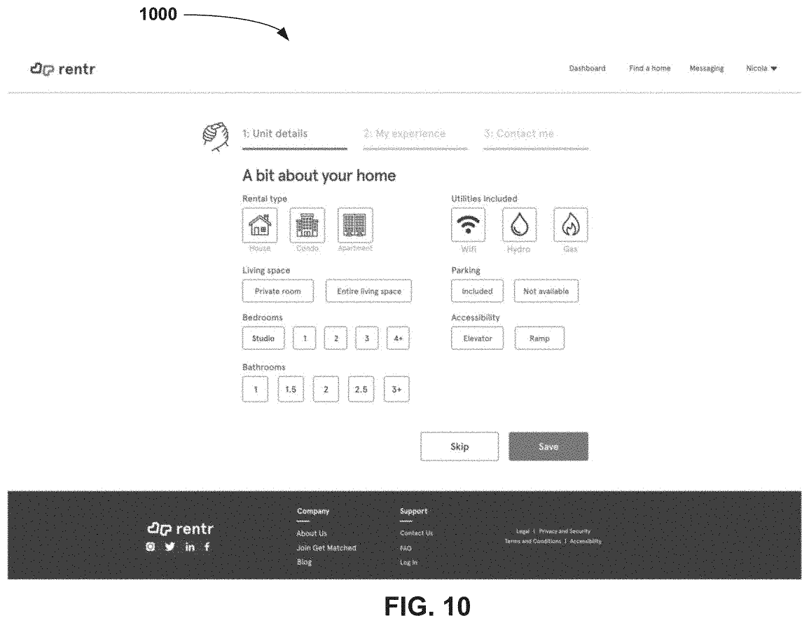

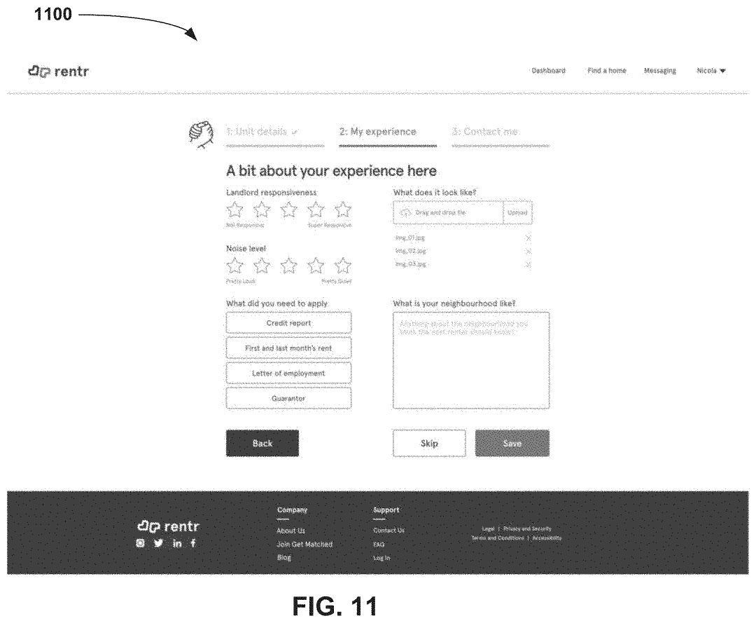

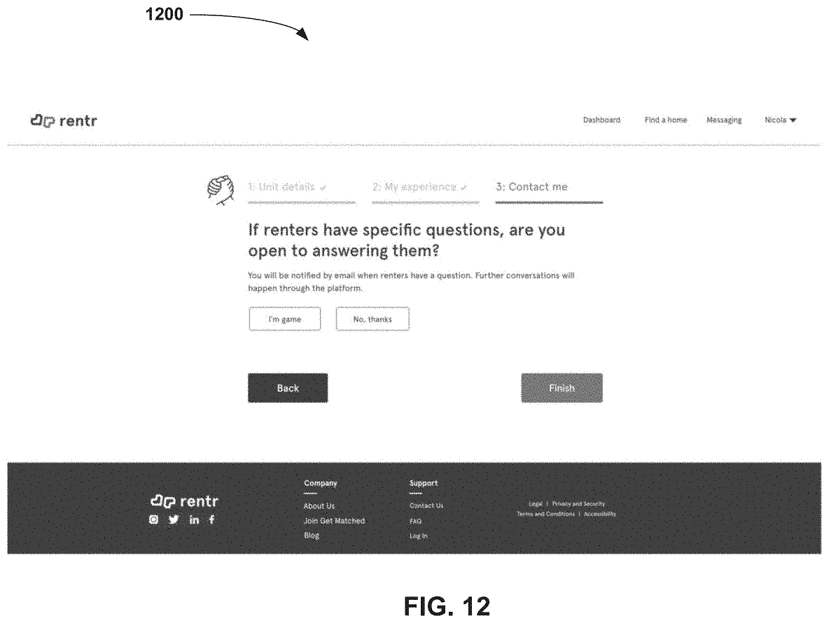

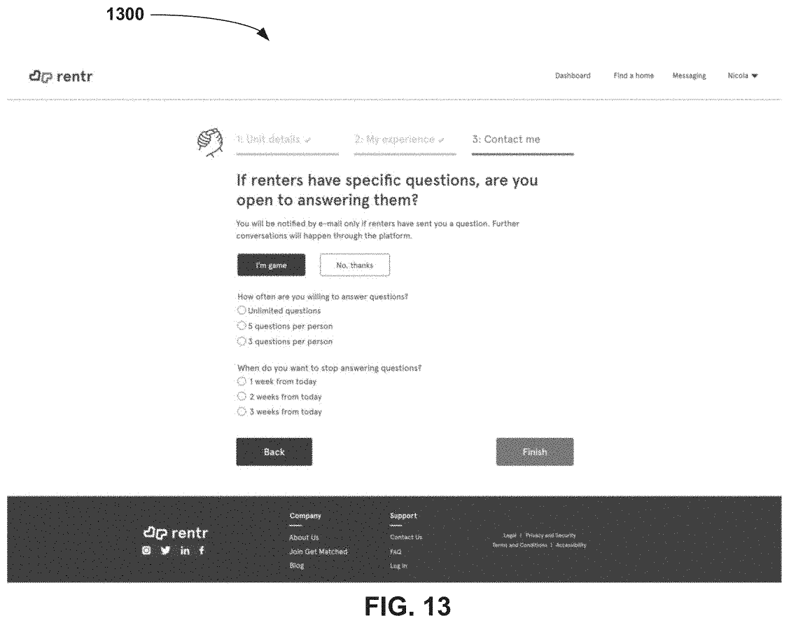

FIGS. 7 to 13 illustrate, in screenshots, an example of supply-side user interface pages 700 to 1300 after login for the electronic rental system 300, in accordance with some embodiments. The supply-side user interface pages allow the user to interact with the system 300 to provide information with respect to their current property. Examples for some steps in FIG. 5 are illustrated.

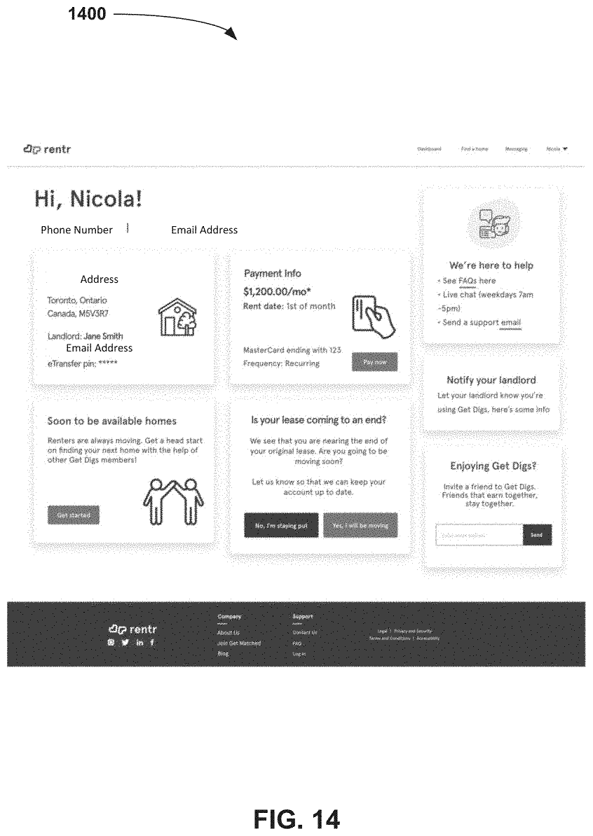

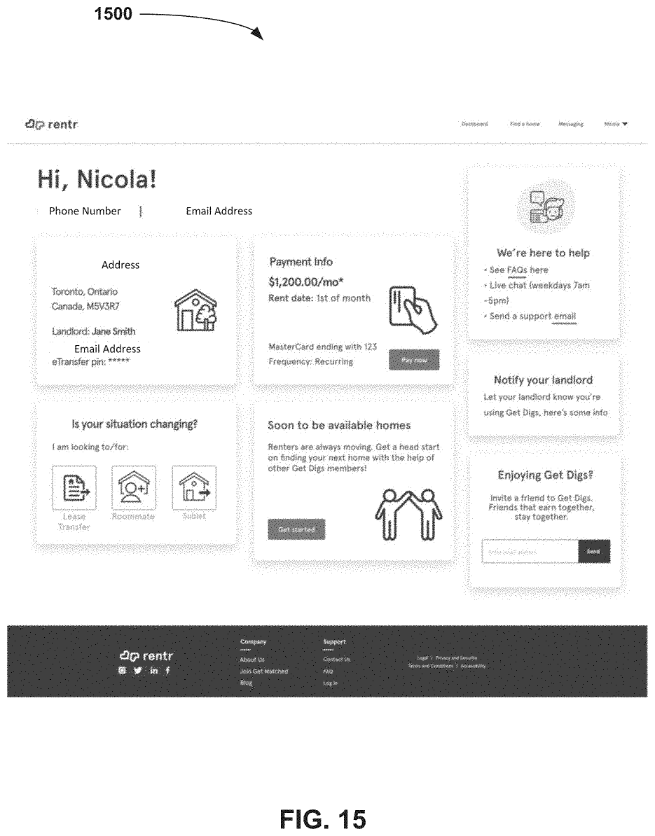

FIGS. 14 to 15 illustrate, in screenshots, an example of dashboards 1400 to 1500 for the electronic rental system 300, in accordance with some embodiments.

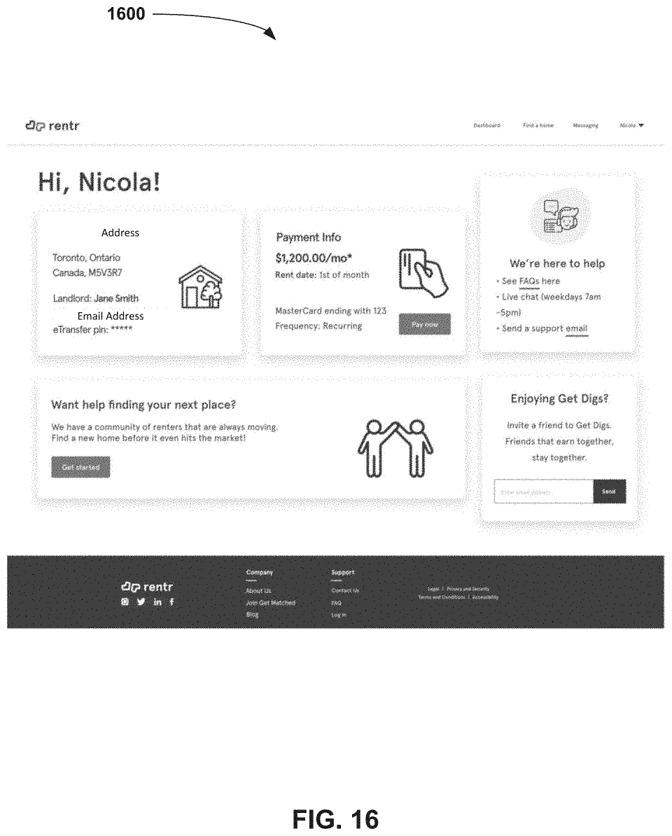

FIG. 16 illustrates, in a screenshot, an example of a demand-side dashboard 1600 for the electronic rental system 300, in accordance with some embodiments.

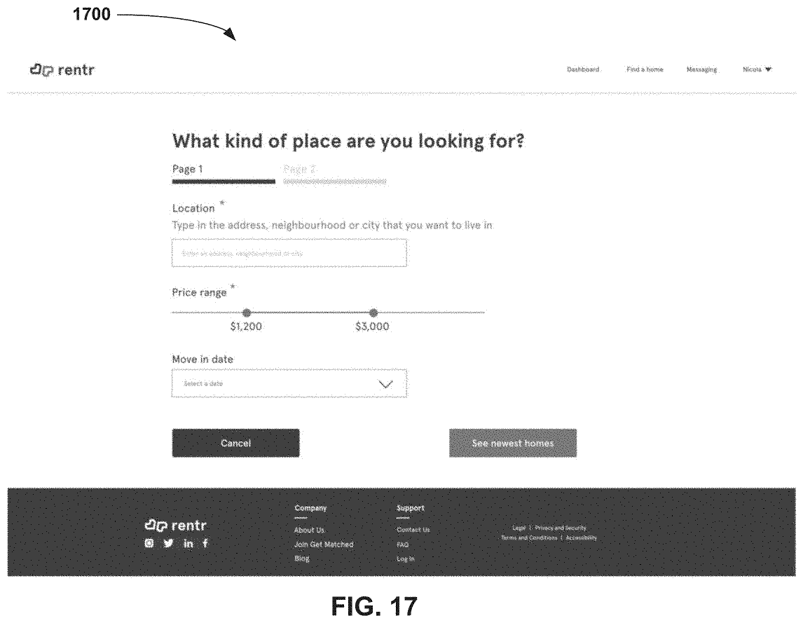

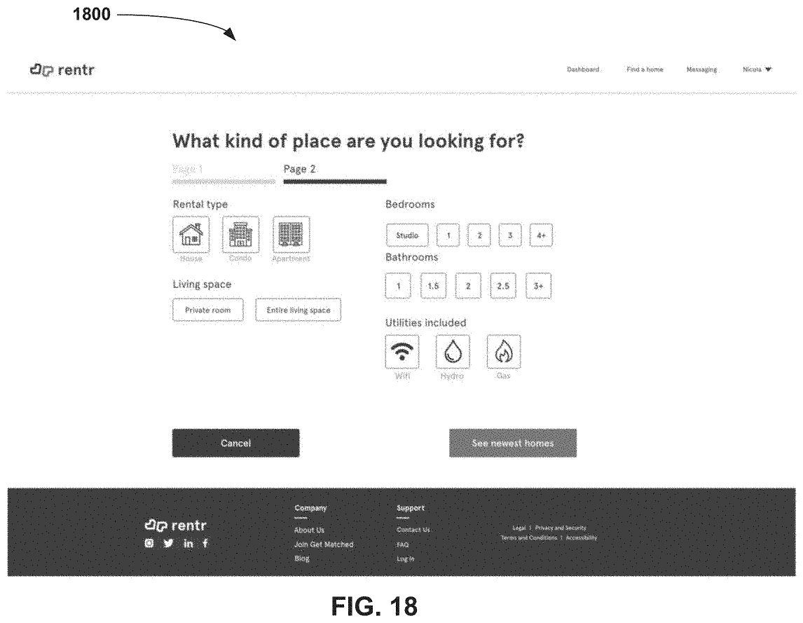

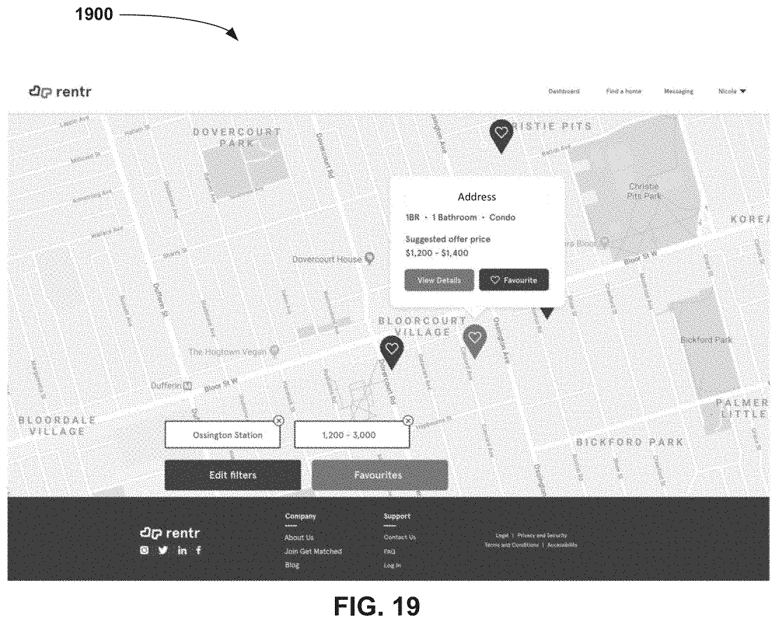

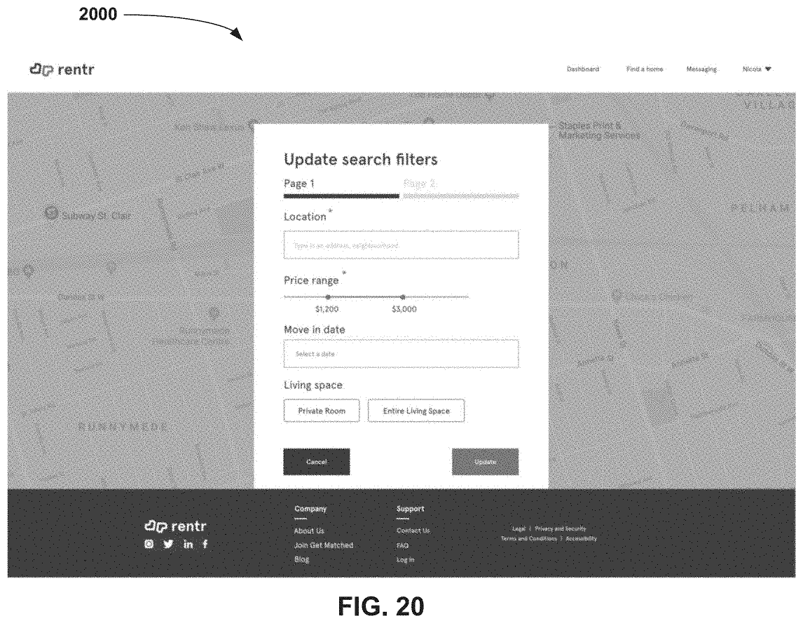

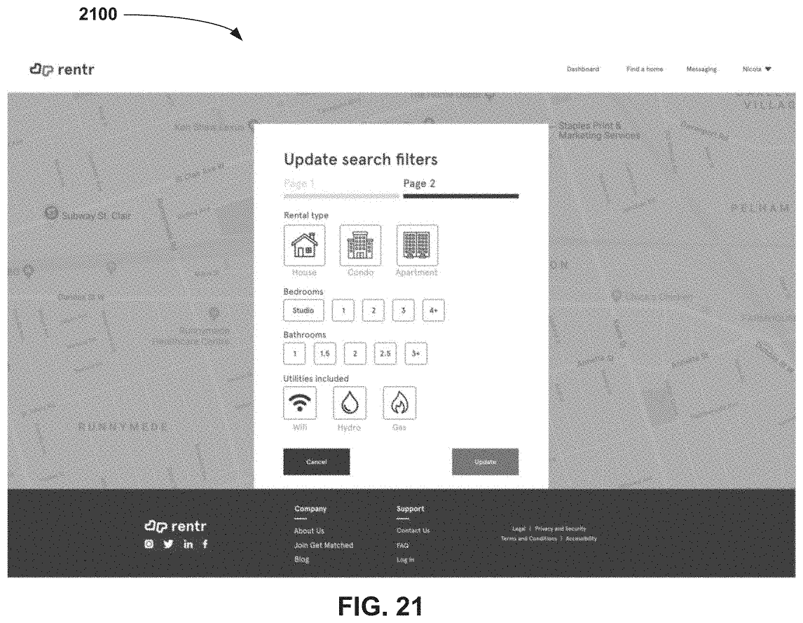

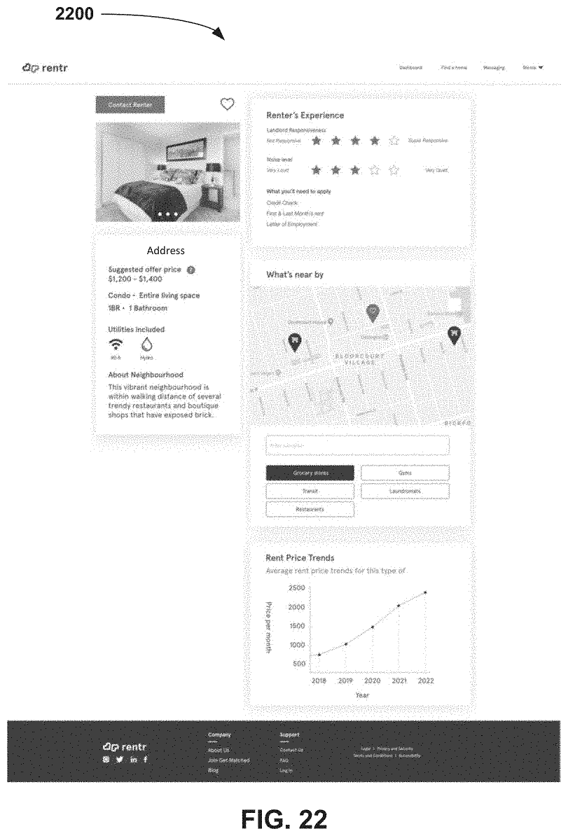

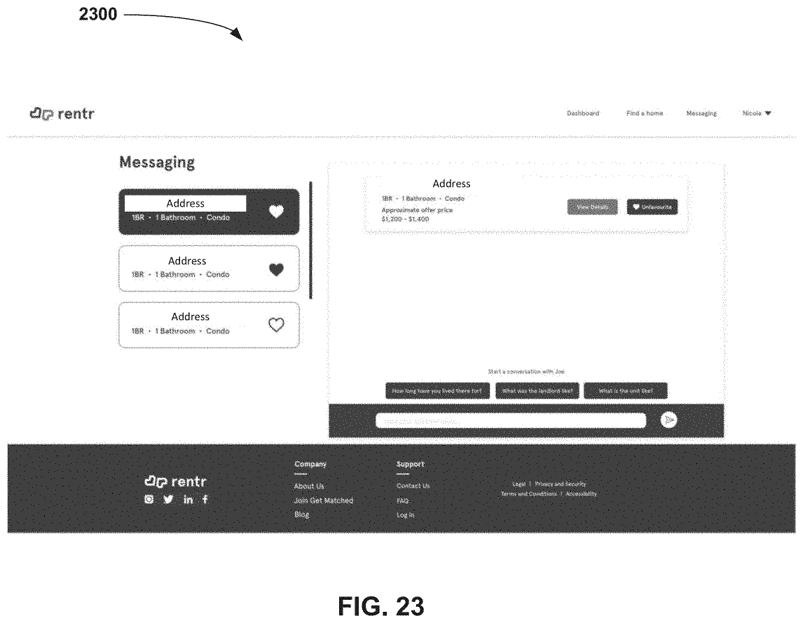

FIGS. 17 to 23 illustrate, in screenshots, an example of demand-side user interface pages 1700 to 2300 after login for the electronic rental system 300, in accordance with some embodiments. The demand-side user interface pages allow the user to interact with the system 300 to search for new rental units. Examples for some steps in FIG. 5 are illustrated.

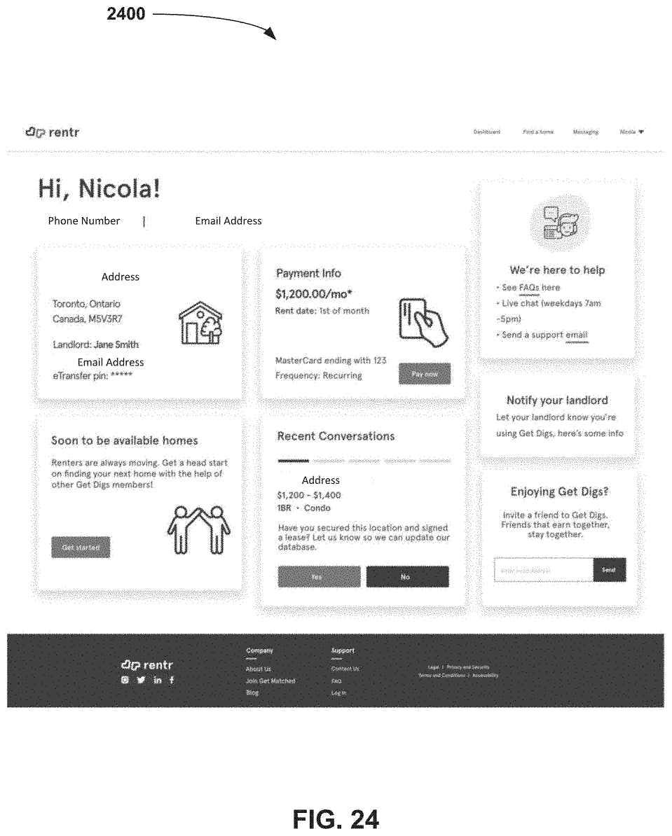

FIG. 24 illustrates, in a screenshot, another example of a demand-side dashboard 2400 for the electronic rental system 300, in accordance with some embodiments.

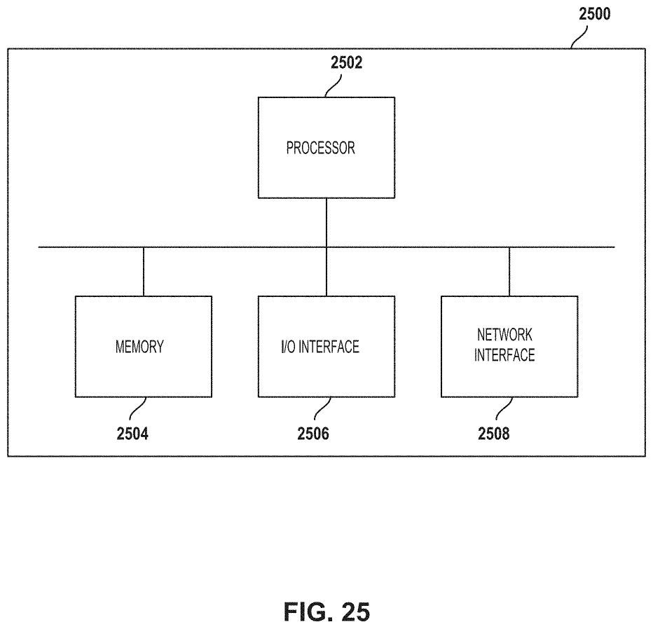

FIG. 25 is a schematic diagram of a computing device 2500 such as a server. As depicted, the computing device includes at least one processor 2502, memory 2504, at least one I/O interface 2506, and at least one network interface 2508.

Processor 2502 may be an Intel or AMD x86 or x64, PowerPC, ARM processor, or the like. Memory 2504 may include a suitable combination of computer memory that is located either internally or externally such as, for example, random-access memory (RAM), read-only memory (ROM), compact disc read-only memory (CDROM).

Each I/O interface 2506 enables computing device 2500 to interconnect with one or more input devices, such as a keyboard, mouse, camera, touch screen and a microphone, or with one or more output devices such as a display screen and a speaker.

Each network interface 2508 enables computing device 2500 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., WMAX), SS7 signaling network, fixed line, local area network, wide area network, and others.

The foregoing discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, references are made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A system comprising at least one processor and a memory storing instructions which when executed by the at least one processor configure the at least one processor to:
provide a demand-side user interface offering at least one limited-supply product or service;
determine a bid price for a user to offer for the at least one limited-supply product or service; and
match the user with the at least one limited-supply product or service.

2. The system as claimed in claim 1, wherein the at least one processor is configured to pre-process data pertaining to the at least one limited-supply product or service, wherein to pre-process said data, the at least one processor is configured to:
extract said data from at least one financial institution data stream; and
aggregate said data.

3. The system as claimed in claim 2, wherein the at least one processor is configured to select the extracted data based on at least one periodic transaction amount.

4. The system as claimed in claim 2, wherein the at least one processor is configured to select the extracted data based on a location associated with the limited-supply product or service.

5. The system as claimed in claim 1, wherein the bid price comprises:
a current price added to an increase price trend.

6. The system as claimed in claim 5, wherein the bid price comprises:
a lower bid price range based on the bid price less a confidence interval; and
a higher bid price range based on the bid price plus the confidence interval.

7. The system as claimed in claim 6, wherein the confidence interval comprises a Z-value factored by a standard deviation of historical rental prices.

8. The system as claimed in claim 1, wherein the at least one processor is configured to:
register a user interested in the at least one limited-supply product or service;
receive information regarding an available limited-supply product or service;
generate a bid price for the available limited-supply product or service; and
send a notification to the user of the bid price for the available limited-supply product or service.

9. The system as claimed in claim 1, wherein the at least one processor is configured to:
register a user interested in a rental property in a location area;
receive information regarding an available rental property in the location area;
generate a bid price for the available rental property in the location area; and
send a notification to the user of the bid price for the available rental property in the location area.

10. A computer-implemented method comprising:
providing, by at least one processor, a demand-side user interface offering at least one limited-supply product or service;
determining, by the at least one processor, a bid price for user to offer for the at least one limited-supply product or service; and
matching, by the at least one processor, the user with the at least one limited-supply product or service.

11. The method as claimed in claim 10, comprising pre-processing data pertaining to the at least one limited-supply product or service, wherein pre-processing said data comprises:
extracting said data from at least one financial institution data stream; and
aggregating said data.

12. The method as claimed in claim 11, comprising selecting the extracted data based on at least one periodic transaction amount.

13. The system as claimed in claim 11, comprising selecting the extracted data based on a location associated with the limited-supply product or service.

14. The method as claimed in claim 10, wherein the bid price comprises:
a current price added to an increase price trend.

15. The method as claimed in claim 14, wherein the bid price comprises:
a lower bid price range based on the bid price less a confidence interval; and
a higher bid price range based on the bid price plus the confidence interval.

16. The method as claimed in claim 15, wherein the confidence interval comprises a Z-value factored by a standard deviation of historical rental prices.

17. The method as claimed in claim 10, comprising:
registering a user interested in the at least one limited-supply product or service;
receiving information regarding an available limited-supply product or service;
generating a bid price for the available limited-supply product or service; and
sending a notification to the user of the bid price for the available limited-supply product or service.

18. The method as claimed in claim 10, comprising:
registering a user interested in a rental property in a location area;
receiving information regarding an available rental property in the location area;
generating a bid price for the available rental property in the location area; and
sending a notification to the user of the bid price for the available rental property in the location area.

19. A non-transitory computer-readable medium having instructions thereon which, when executed by a processor, perform a method comprising:
providing a demand-side user interface offering at least one limited-supply product or service;
determining a bid price for user to offer for the at least one limited-supply product or service; and
matching the user with the at least one limited-supply product or service.
